(19) United States
(12) Patent Application Publication
(10) Pub. No.: US 2004/0114886 A1
(43) Pub. Date: Jun. 17, 2004

(54) Systems and methods for reducing optical fiber splice loss

(75) Inventors: Erling D. Christensen, Copenhagen (DK); Thomas Rafn, Koebenhavn (DK); Lars Riis, Broenshoej (DK); Torben E. Veng, Roskilde (DK)

Correspondence Address: PRIEST & GOLDSTEIN PLLC, 5015 SOUTHPARK DRIVE, SUITE 230, DURHAM, NC, 27713-7736, US

(73) Assignee: Fitel USA Corp., Norcross, GA

(21) Appl. No.: 10/317,955

(22) Filed: Dec. 12, 2002

(51) Int. Cl. G02B 6/255

(52) U.S. Cl. 385/96; 65/501; 65/407

(57) ABSTRACT

Systems and methods are described for reducing optical fiber splice loss. A torch is described for performing a thermally-diffused expanded core (TEC) technique. The torch includes a hollow body. A conduit delivers a flammable gas to the hollow body. The flammable gas streams out of an array of orifices formed in the hollow body. The orifices are shaped and arranged in the array such that when the streaming gas is ignited, a substantially continuous elongated flame is created having a desired heating profile. Further described are a thermal treatment station incorporating a line torch and techniques for using an elongated flame to reduce optical fiber splice loss.

### BACKGROUND OF THE INVENTION

1. Field of the Invention

The present invention relates generally to improvements in the field of fiber optics, and particularly to advantageous aspects of systems and methods for reducing optical fiber splice loss.

2. Description of Prior Art

An optical fiber is a conduit, typically fabricated from a highly pure form of silica (SiO₂), that is used to transmit data signals in the form of pulses of coherent light. In order for the transmitted signals to propagate correctly through the fiber, dopants are added to the silica to create a central core running down the length of the fiber surrounded by a number of precisely formed layers. The core and surrounding layers together form an optical pathway, typically having a cylindrical shape, down the length of the fiber. This optical pathway is referred to as the fiber's “modefield.”

Dopants are typically highly stable in an optical fiber at normal operating temperatures. However, at high temperatures, fiber dopants begin to diffuse, causing a change in the fiber's refractive index profile. In particular, this diffusion of fiber dopants typically causes an expansion of the fiber's core, and therefore an expansion of the fiber's modefield diameter.

For a number of reasons, dopant diffusion and modefield diameter have become increasingly significant issues in newer optical fiber designs. First, in order to achieve certain desired optical properties, certain newer fiber designs use high concentrations of certain dopants, such as fluorine, that are more sensitive to heat than other dopants. See, e.g., Krause et al., “Splice Loss of Single-Mode Fiber as Related to Fusion Time, Temperature, and Index Profile Alteration,” J. Lightwave Technol., vol. LT-4, No. 7, 837-49 (1986). In addition, certain new fiber designs have modefield diameters that are significantly narrower than modefield diameters of older fibers. Splicing together an older fiber design with one of these newer designs has proven to be problematic, both because of the modefield diameter mismatch, and because of the rapid diffusion of dopants in the newer fiber design.

Any sudden perturbation or discontinuity along an optical pathway may lead to a phenomenon known as “mode coupling,” in which the propagation characteristics of a portion of the optical signal become altered, causing that portion of the optical signal to drop out. When two fibers having different modefield diameters are spliced together, the modefield diameter mismatch at the splice point represents such a perturbation. The resulting attenuation in the transmitted signal is referred to as “splice loss.” Splice loss is an increasingly important issue in the design of optical transmission systems, particularly as optical transmission lines increase in length. Although electro-optical devices may be used to boost an optical signal, it is highly desirable to create optical transmission lines with few, if any, such boosting devices.

Various techniques have been developed to address the issue of splice loss resulting from modefield diameter mismatch. In one technique, known as a “thermally-diffused expanded core” (TEC) technique, a pair of fusion-spliced fibers are loaded into a heat treatment station, and a controlled heat is applied to the splice point. A TEC technique is described in Shiraishi et al., “Beam Expanding Fiber Using Thermal Diffusion of the Dopant,” J. Lightwave Technol., vol. LT-8, No. 8, 1151-61 (1990). The controlled heat causes a diffusion of the dopants in the smaller modefield fiber. This dopant diffusion results in a modefield expansion in the smaller modefield fiber, thereby reducing modefield mismatch.

Although the TEC technique typically results in a reduction in splice loss, it suffers from a number of drawbacks. First, some splice loss still remains. It is desirable to find ways to reduce splice loss even further. In addition, it is desirable to find ways to improve repeatability of splice loss results, and to improve the strength of the TEC-treated splice.

### SUMMARY OF INVENTION

Aspects of the invention provide systems and methods for reducing optical fiber splice loss, improving repeatability of splice loss reduction, and strengthening thermally treated splices. One aspect of the invention provides a torch for performing a thermally-diffused expanded core (TEC) technique. The torch includes a hollow body. A conduit delivers a flammable gas to the hollow body. The flammable gas streams out of an array of orifices formed in the hollow body. The orifices are shaped and arranged in the array such that when the streaming gas is ignited, a substantially continuous elongated flame is created having a desired heating profile. Further aspects of the invention provide a thermal treatment station incorporating a line torch and methods for using an elongated flame to reduce optical fiber splice loss.

Additional features and advantages of the present invention will become apparent by reference to the following detailed description and accompanying drawings.

### BRIEF DESCRIPTION OF DRAWINGS

FIGS. 1 and 2 show cross section diagrams of first and second optical fibers having different modefield diameters.

FIG. 3 shows a diagram of an optical fiber transmission line fabricated by splicing together the first and second fibers shown in FIGS. 1 and 2.

FIG. 4 shows a diagram of a cylindrical torch according to the prior art.

FIG. 5 shows a diagram of the optical fiber transmission line shown in FIG. 3 being treated by a thermally-diffused expanded core (TEC) technique using the cylindrical torch shown in FIG. 4.

FIG. 6 shows a diagram of the optical fiber transmission line shown in FIG. 3 after the TEC treatment shown in FIG. 5 has been completed.

FIG. 7 shows a diagram of a line torch according to an aspect of the present invention.

FIG. 8 shows a diagram of the optical fiber transmission line shown in FIG. 3 being TEC-treated using the torch shown in FIG. 7.

FIG. 9 shows a diagram of the optical fiber transmission line shown in FIG. 3 after the TEC treatment shown in FIG. 7 has been completed.

FIG. 10 shows a diagram of another example of a line torch according to the present invention.

FIG. 11 shows a table setting forth the position of the orifices on the line torch shown in FIG. 10.

FIG. 12 shows a diagram of a further example of a line torch according to the present invention.

FIG. 13 shows a table setting forth the position of the orifices on the line torch shown in FIG. 12.

FIG. 14 shows a diagram of a further example of a line torch according to the present invention.

FIG. 15 shows a table setting forth the position of the propane orifices on the line torch shown in FIG. 14.

FIG. 16 shows a diagram of a further example of a line torch according to the present invention.

FIG. 17 shows a table setting forth the position of the propane orifices on the line torch shown in FIG. 16.

FIG. 18 shows a table setting forth the position of the oxygen orifices on the line torch shown in FIG. 16.

FIG. 19 shows a diagram of a line torch system suitable for creating high-strength splices.

FIG. 20 shows a diagram of a heat treatment station incorporating a line torch according to the present invention.

FIGS. 21-27 show a series of graphs and tables setting forth results obtained from practicing various aspects of the present invention on various splice combinations.

FIG. 28 shows a diagram of a pair of spliced optical fibers having the same modefield diameter.

FIG. 29 shows a diagram of the spliced fibers shown in FIG. 28 being TEC-treated by a line torch according to a further aspect of the invention.

FIG. 30 shows a diagram of the spliced fibers after the TEC treatment has been completed.

FIGS. 31-33 show a series of diagrams illustrating alternative configurations for the line torch.

FIG. 34 shows a flowchart of a method for reducing splice loss according to a further aspect of the invention.

### DETAILED DESCRIPTION

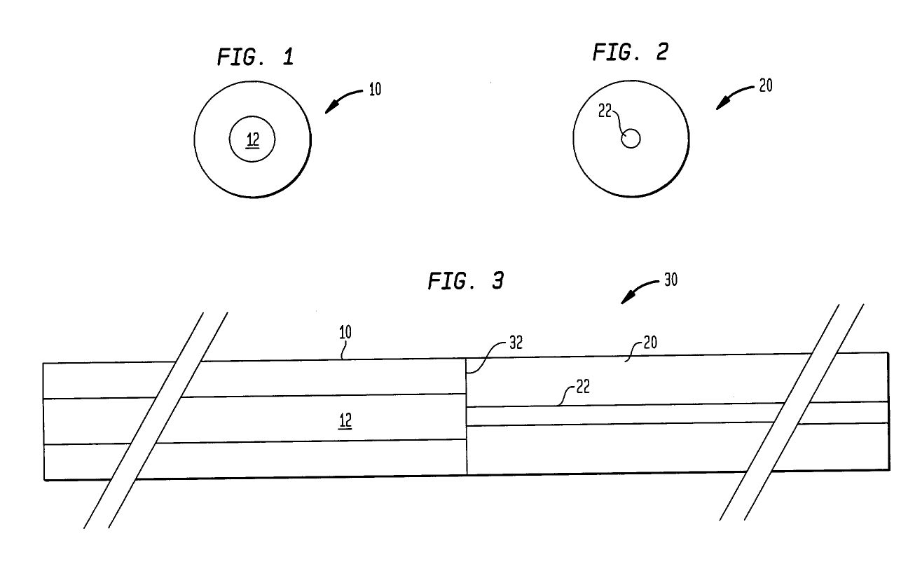

FIGS. 1-3 are a series of diagrams illustrating the problem of modefield mismatch. FIG. 1 shows a cross section diagram, not drawn to scale, of a first optical fiber 10 having a cylindrical modefield 12 therethrough. As mentioned above, the modefield is created by the optical interaction of a core region and surrounding layers that have been doped to create a desired refractive index (RI) profile. FIG. 2 shows a cross section diagram, not drawn to scale, of a second optical fiber 20 also having a cylindrical modefield 22 therethrough. It will be seen that the second fiber modefield diameter (MFD) is significantly smaller than the first fiber MFD. FIG. 3 shows a diagram of an optical fiber transmission line 30 constructed by using a fusion splicer to splice together the first fiber 10 and the second fiber 20 at a splice point 32. As shown in FIG. 3, there is a significant MFD mismatch at the splice point 32, leading to splice loss.

One way to reduce the modefield diameter mismatch is to expand the modefield diameter of the second fiber to match that of the first fiber. It is possible to cause a modefield expansion in the second fiber by programming the fusion splicer used to perform the splice to make an extended application of heat to the splice. However, this approach is not practical with certain optical fibers, such as those that have been heavily doped with fluorine. Because fluorine diffuses at a relatively rapid rate, and because of the high temperatures generated by a fusion splicer, it has proven to be extremely difficult to use the fusion splicer to produce the desired modefield expansion in these fibers.

Therefore, a post-splice TEC technique is typically used to expand the MFD of the second fiber to reduce the MFD mismatch at the splice point. In a TEC technique, after the fusion splice has been completed, the spliced fibers are loaded into a thermal treatment station, where heat is applied to the splice point according to a controlled heating profile. The heating profile causes the fiber dopants to diffuse, resulting in an expansion of the second fiber's MFD.

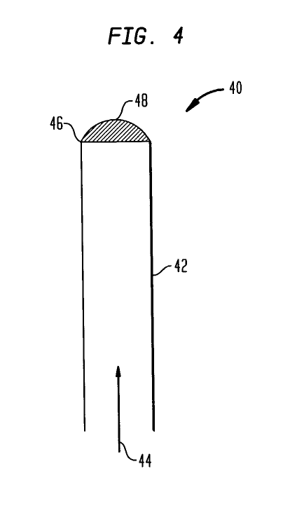

FIG. 4 shows a diagram of a cylindrical torch 40 that is typically used in current thermal treatment stations to perform a TEC technique. As shown in FIG. 4, the torch 40 comprises a cylindrical tube 42 that receives a flammable gas, such as propane, from an inlet, represented by arrow 44. The tube 42 includes an open end 46 from which a stream of the flammable gas is expelled and ignited to form an open flame 48 that is used to apply heat to the spliced fibers.

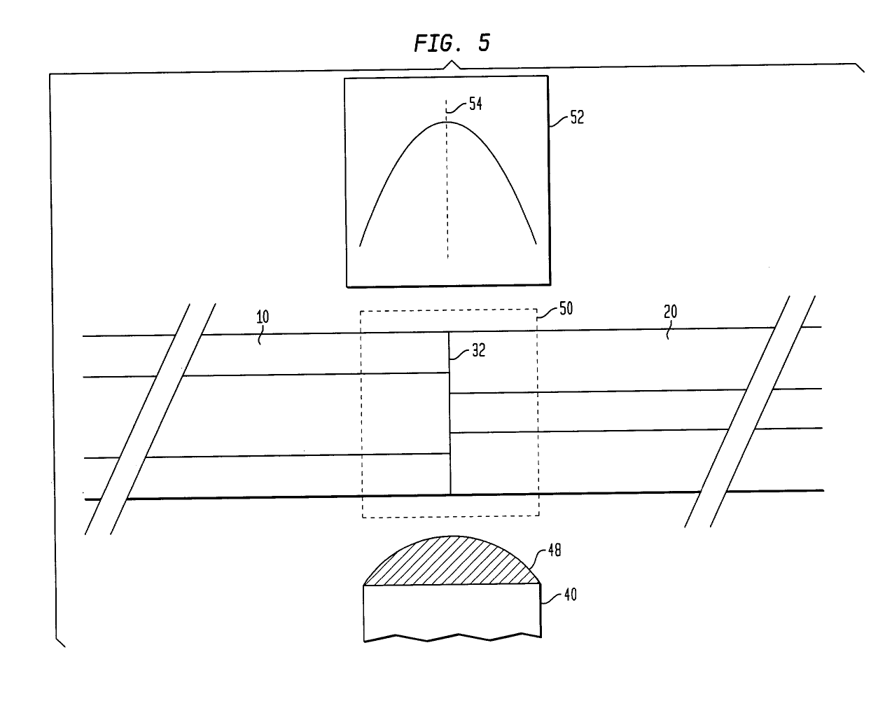

In FIG. 5, the spliced fibers 10 and 20 have been loaded into a thermal treatment incorporating the torch 40 shown in FIG. 4. The fibers 10 and 20 have been positioned such that the splice point 32 is located over the flame 48 from the cylindrical torch 40. The flame 48 creates a heat zone 50 around the splice point 32. An illustrative heating profile 52 is drawn above the splice point 32, showing the temperature of the heat zone 52 as a function of position. The heating profile 52 includes a broken line 54 illustrating the location of the splice point 32. As shown in the heating profile 52, the fibers 10 and 20 are positioned such that the splice point 32 is located at the peak temperature of the heat zone 50.

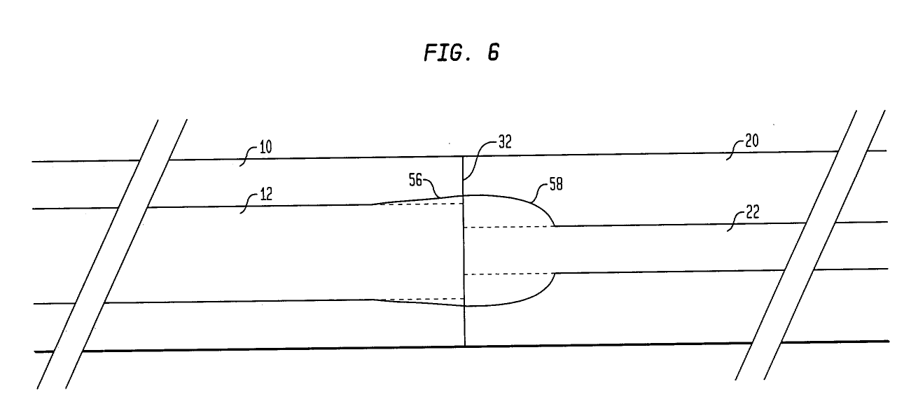

The heating process continues until a desired amount of dopant diffusion has taken place. The spliced fibers 10 and 20 are then removed from the heat treatment station. FIG. 6 shows a diagram of the spliced fibers 10 and 20 after the heat treatment has been completed. As shown in FIG. 6, the first and second fiber modefields 12 and 22 now include expanded regions 56 and 58 proximate to the splice point. In the present example, it is assumed that dopant diffusion occurs at a faster rate in the second fiber 20 than in the first fiber 10. This difference in diffusion rates would occur, for example, where the second fiber 20 is dispersion compensating fiber (DCF) or another fiber that has been heavily doped with fluorine, and where the first fiber 10 is a standard single-mode fiber (SSMF). Thus, after the TEC treatment, both modefields 12 and 22 have expanded to approximately the same diameter, thereby reducing modefield mismatch at the splice point 32.

However, splice loss continues to be an issue. One reason for this is that DCF and other premium fibers are doped to have steep dispersion slopes. These fibers are therefore typically highly sensitive to even relatively minor changes in refractive index. Thus, while reducing modefield mismatch, the TEC treatment may itself introduce perturbations and discontinuities in the second fiber modefield in the TEC-treated portion of the fiber. Because of the sensitivity of premium fibers to changes in refractive index, these perturbations and discontinuities, even if relatively minor, may nonetheless produce a significant amount of loss.

According to an aspect of the present invention, these perturbations and discontinuities caused by the TEC treatment are reduced by decreasing the heating gradient across the heating zone during the TEC treatment. In particular, the heating gradient is decreased by increasing the length of the heating zone, and tailoring the heating profile to produce a smoother modefield transition across the heating zone. As discussed below, it has been confirmed in experimental trials that modifying the TEC technique in this way leads to a significant decrease in splice loss.

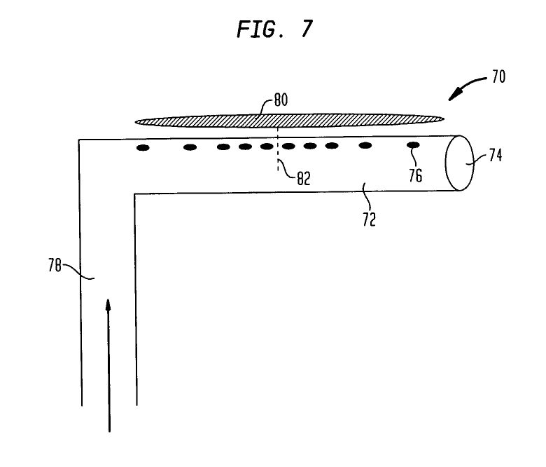

FIG. 7 shows a diagram of an improved torch 70, referred to herein as a “line torch,” for performing a TEC technique. As shown in FIG. 7, the line torch 70 includes a hollow body 72 fabricated from a suitable material, such as stainless steel. The hollow body 72 is closed off at one end 74. An array of orifices 76 is formed in the hollow body 72. The 74 orifices are arranged in a substantially linear configuration. An inlet 78 connected to the hollow body 72 provides a suitable flammable gas, such as propane, to the hollow body 72. The orifices 76 are sized and positioned with respect to each other such that when flammable gas is streamed through the orifices 76 and ignited, a substantially continuous elongated flame 80 is formed.

In the line torch 70 shown in FIG. 7, ten orifices 76 are shown that are arranged symmetrically around the center of the array, indicated by a broken line 82. The size and spacing of the orifices 76 in the array are chosen such that the flame 80 has a smooth, continuous heating profile. The heating profile of the flame 80 is tailored by varying the spacing of the orifices 76 in the array. In addition, the heating profile may also be tailored by varying the size of the orifices 76. It should also be noted that although the array of orifices 76 is illustrated as substantially linear in FIG. 7, it may also be possible use an array of orifices 76 in which some or all of the orifices are not arranged in a strictly linear fashion.

As shown in FIG. 7, the orifices 76 towards the center of the linear array are spaced relatively closely together, whereas the orifices 76 towards the left and right ends of the linear array are spaced relatively far apart. In this example, the orifices 76 are all the same size. Thus, the relatively close spacing of the orifices 76 towards the center of the linear array produces a flame 80 having a heating profile with higher temperatures towards the center of the heating profile. A similar effect could be created using evenly spaced orifices 76 of different sizes. The relative intensity of the flame 80 could be increased by using larger orifices, and decreased by using smaller orifices 76. Of course, desired effects may be achieved by varying both the size and spacing of the orifices 76.

It should be noted that in FIG. 7 the heating profile of the elongated flame 80 may be asymmetrical because the flammable gas is being fed from one end of the linear array of orifices 76. The flame may be somewhat more intense at the end of the array that is closer to the gas input, because the gas has a slightly higher pressure at that end, causing more gas to be released and ignited than at the other end. If a symmetrical heating profile is desired, it may be accomplished by providing symmetrical gas inputs at both ends of the linear array, or by making suitable adjustments to the size or spacing, or both, of the orifices. For example, the orifices 76 at the far end of the array may be made larger, or spaced more closely together, than the orifices 76 at the near end of the array. It should further be noted that, under certain circumstances, some asymmetry in the heating profile may be desirable. For example, where the pair of spliced fibers being treated is of dissimilar types, it may be desirable to raise one of the fibers to a higher temperature than the other.

The overall length of the array of orifices and the resulting flame and heating zone are determined empirically. In principle, the longer the heat zone, and the more gradual the transition, the better. Further, in principle, a heating zone of any length can be created by using a long enough hollow body 72 and a suitable number of orifices 76. However, it has been found that acceptable results, such as those discussed below, have been obtained with heat zone lengths not exceeding 25 mm. The heat zone length is significant because there are practical limits to how much bare fiber can be exposed in a splicing operation. In addition, typically, there are length requirements for packaging the completed splice.

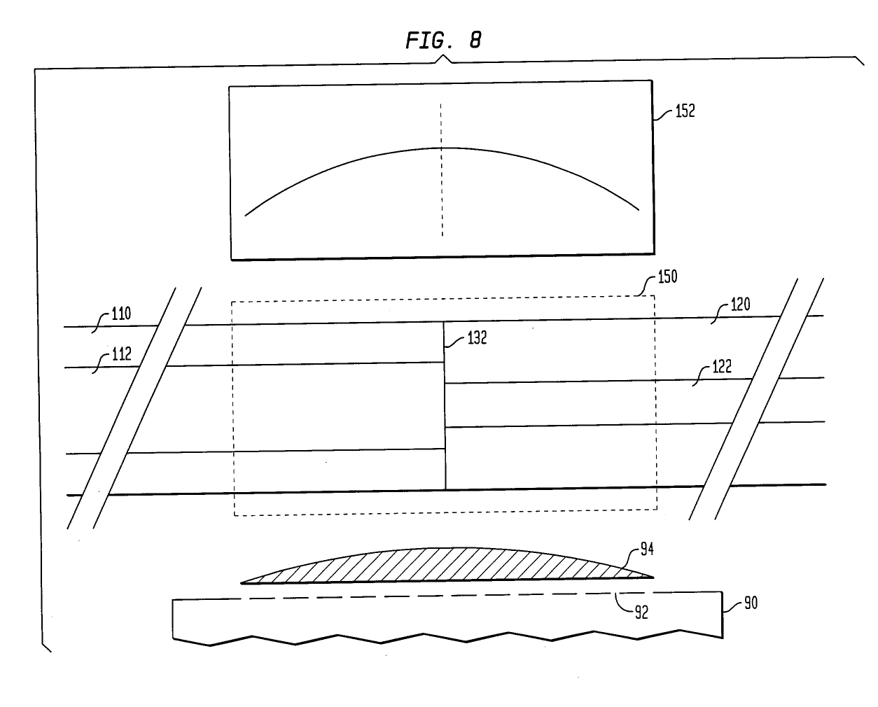

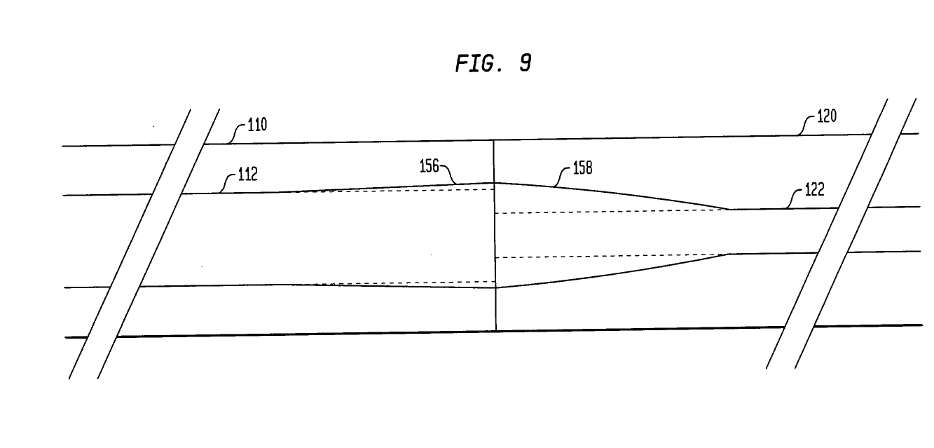

The operation of the line torch 70 is illustrated in FIGS. 8 and 9. In FIG. 8, a pair of spliced fibers 110 and 120 having respective modefields 112 and 122 with different diameters have been fusion spliced together at a splice point 132 and then loaded into a thermal treatment station incorporating a line torch 90. The line torch includes an array of orifices 92 that release a stream of propane, or other flammable gas, that is ignited to form an elongated flame 94. The spliced fibers 110 and 120 are positioned such that the fibers 110 and 120 are aligned over the array of orifices 92, with the splice point 132 located over the peak of the elongated flame 94. The elongated flame 92 creates a heating zone 150 around the splice point 132. The temperature profile 152 of the heating zone 150 is illustrated at the top of FIG. 8. The heat treatment continues until the first and second modefields 112 and 122 are matched at the splice point 132. The fibers 110 and 120 are then removed from the heat treatment station.

FIG. 9 shows a diagram of the fibers 110 and 120 after the TEC treatment illustrated in FIG. 8 has been completed. As shown in FIG. 9, the transition regions 156 and 158 of the first and second fibers 110 and 120 display a more gradual and smoother tapering than the spliced fibers 10 and 20 shown in FIG. 6. This smoother and more gradual tapering results in a substantially adiabatic tapered transition region 158 in the second fiber 120, that is, a transition region 158 with virtually no mode coupling. In addition, as discussed below, it has been found the line torch improves repeatability of TEC treatment results. As further discussed below, a line torch can significantly decrease the amount of time required for the TEC treatment and can also be used to create a high-strength splice, greater than 200 kpsi.

It should be noted that the above described technique may be varied in a number of ways without departing from the spirit of the invention. For example, it may be desirable, under certain circumstances, for the splice point of the spliced fibers to be offset from the peak of the elongated flame. It may also be desirable to skew the longitudinal axis of the spliced fibers relative to the array of orifices. Such a skewing of the fiber position may be used, for example, to make adjustments to the temperature profile of the heating zone.

It should further be noted that although the present invention is described with respect to fibers that are heavily doped with fluorine, the present invention may also be used with other types of fiber. For example, other types of dopants may be used to create a steeply sloped optical fiber for which a relatively slight change in index profile results in a rather large change in modefield distribution. In that case, even if no fluorine is used, a TEC technique may still be required to create a sufficiently smooth, tapered transition in the vicinity of a splice.

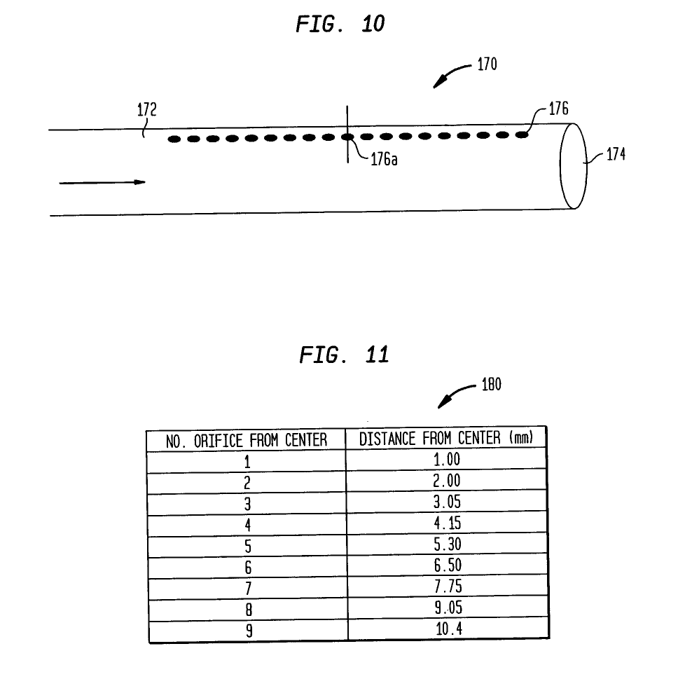

FIGS. 10-18 are a series of diagrams and tables illustrating four different examples of line torch configurations incorporating the basic principles of the line torch shown in FIG. 7. FIG. 10 shows a diagram of the first of the four torch configurations. This torch 170 includes a hollow body 172 fabricated from a stainless steel tube having an inner diameter of 5.0 mm and an outer diameter of 6.0 mm. One end 174 of the torch 170 is sealed, and a series of 19 orifices 176, having a diameter of 0.34 mm, are drilled into the hollow body 172. The orifices 176 are spaced with respect to each other to produce a desired heating profile. In the torch 170 shown in FIG. 10, the 19 orifices 176 are arranged symmetrically around a central orifice 176a, with nine orifices 176 on the left side and nine orifices on the right side of the central orifice 176a. FIG. 11 shows a table 180 setting forth the distance, in millimeters, of each orifice 176 from the central orifice 176a. Propane was fed from an inlet through the line torch 170 at a flow rate of 13 ml/min.

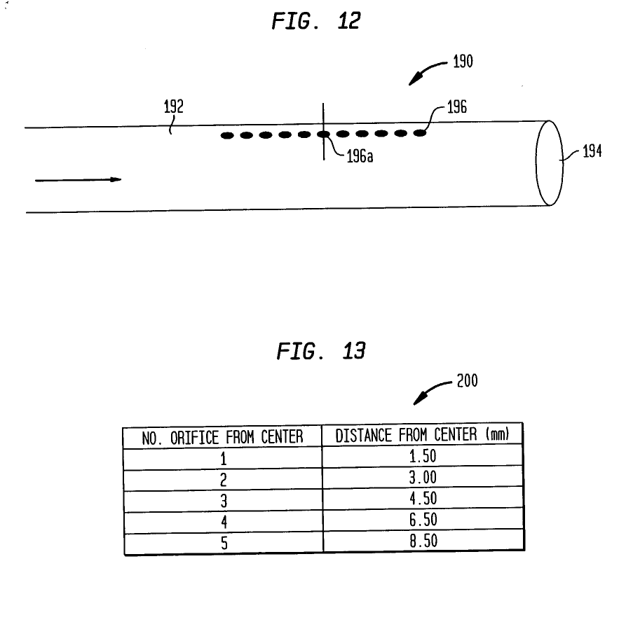

FIG. 12 shows another example of a line torch 190 according to the invention. Again, the torch 190 comprises a hollow body 192 fabricated from a stainless steel tube that is closed at one end 194. The tube inner diameter is 5.0 mm and the outer diameter is 6.0 mm. A series of 11 orifices 196, having a diameter of 0.34 mm, were drilled into the tube. The 11 orifices 196 are arranged symmetrically, with five orifices 196 on the right side and five orifices 196 on the left side of a central orifice 196a. FIG. 13 shows a table 200 setting forth the distance, in millimeters, of each orifice 196 from the central orifice 196a.

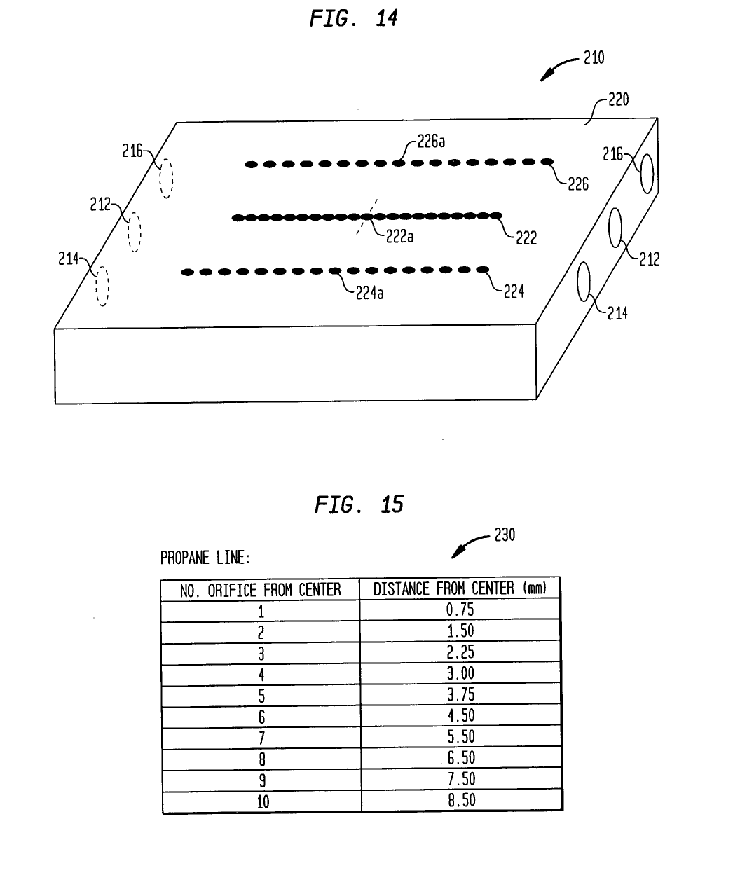

FIG. 14 shows another example of a line torch 210 according to the invention. In this example, the line torch 210 was created by drilling a 2-mm central conduit 212 through a stainless steel block 220. In addition, two other 2-mm conduits 214 and 216 were drilled through the block 220 on both sides of the central conduit 212. The center-to-center distance between the side conduits 214 and 216 and the central conduit 212 is 2.5 mm. The central conduit 212 is used to carry propane or other flammable gas, and the two side conduits 214 and 216 are used to carry oxygen. The conduits 212, 214 and 216 are drilled all the way through the block 220, providing inlets at both ends of the block 220.

Three linear arrays of orifices 222, 224 and 226, each having a diameter of 0.34 mm, were drilled into the block 220, each corresponding to a respective conduit 212, 214, and 216. The arrays 222, 224, and 226 are parallel to each other, and are separated from each other by a distance of 2.5 mm. There are 17 orifices for each oxygen conduit and 21 orifices for the propane conduit. The respective central orifices 222a, 224a, 226a in each of the three arrays of orifices are aligned with each other. The oxygen orifices are evenly spaced apart from each other at a distance of 1.5 mm.

FIG. 15 shows a table 230 setting forth the respective distances for each of the propane orifices 222 from the central propane orifice 222a. The orifices 222 are symmetrically spaced around the central orifice 222a. The rate of total oxygen flow for the two side conduits 214 and 216 is 150 mln/min. The rate of propane flow is 16 ml/min.

As mentioned above, adding oxygen in this manner may be used to selectively increase the temperature of the propane flame, thereby increasing the rate of dopant diffusion in the spliced fibers being treated. In addition, oxygen serves to remove hydroxyl (—OH) radicals that may be present at the surface of spliced fibers during the TEC process. A higher temperature flame decreases the amount of time required for a TEC technique. In addition, higher temperatures may be used in applying a TEC technique to other types of fibers. In the present example, the smaller modefield diameter fiber is heavily doped with fluorine. However, it would be possible to use higher temperatures for applying a TEC technique to erbium-doped fibers, for example. It is not intended to limit the present invention to any particular type of fiber.

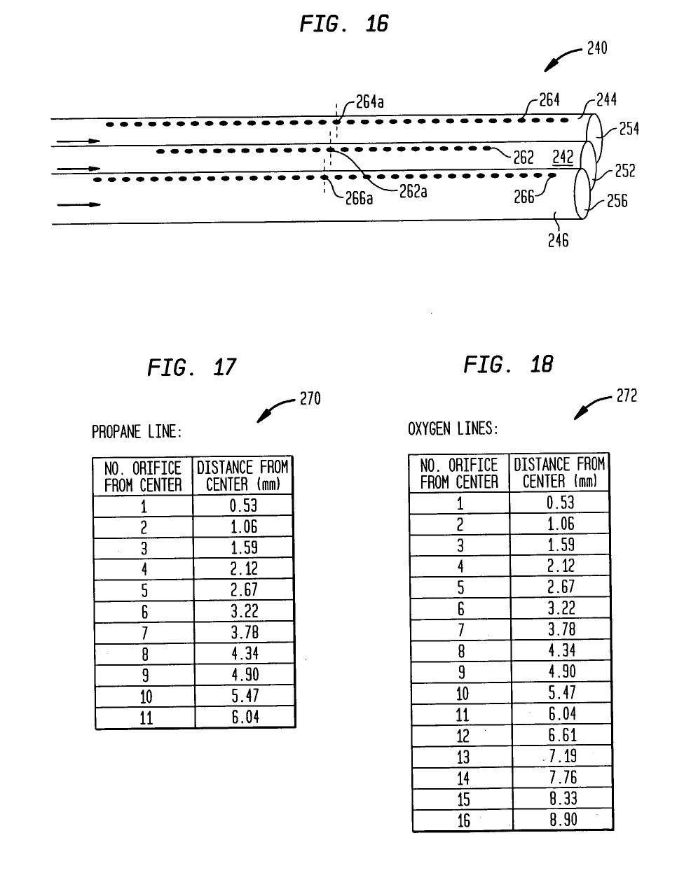

FIG. 16 shows a diagram of another example of a line torch 240 according to the present invention. The torch 240 is fabricated from three separate stainless steel tubes 242, 244 and 246, each having an inner diameter of 2.0 mm and an outer diameter of 3.0 mm. The central tube 242 is used to carry propane, or other suitable flammable gas, and the two side tubes 244 and 246 are used to carry oxygen. Each of the tubes 242, 244 and 246 is closed at one end 252, 254 and 256, and has a linear array of orifices 262, 264 and 266, having a diameter of 0.34 mm, drilled therein. The distance between the arrays is 3.0 mm.

There are 23 orifices in the propane tube 252, and 33 orifices in each oxygen tube 254 and 256. FIG. 17 shows a table 270 setting forth the respective distances of the propane orifices 262 from the central propane orifice 262a, and FIG. 18 shows a table 272 setting forth the respective distances of the oxygen orifices 264 and 266 from the central oxygen orifices 264a and 266a. The central propane and oxygen orifices 262a, 264a, 266a are aligned with each other.

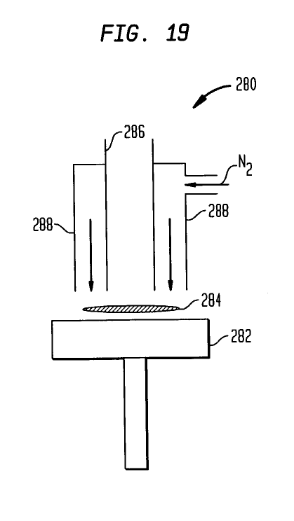

FIG. 19 shows a diagram of a torch system 280 according to a further aspect of the invention. The torch system includes a line torch 282, such as any one of the line torches shown in FIGS. 9-18. The line torch 282 forms an elongated flame 284. A chimney 286 is positioned over the flame 284. The chimney 286 is surrounded by a conduit 288 that is used to deliver a purging gas, such as nitrogen or argon, to the surface of the spliced fibers being treated.

The purging gas causes dust and other particulate matter to be purged from the surface of the optical fibers throughout the TEC process. Purging the fiber surfaces improves the quality of the polish of the treated fibers, and results in a strengthened splice. For example, certain applications, such as submarine applications, require a splice strength of 200 kpsi or greater. The system shown in FIG. 19 can be used to achieve such high-strength splices, particularly where oxygen is added to the line torch flame, such as in the torch configurations shown in FIGS. 14 and 16, discussed above. It should be noted that although the use of a purging gas improves splice strength, it may also serve to decrease the temperature of the heating zone, thus tending to increase processing time. Thus, adjustments may have to be made to the propane and oxygen streams to achieve a desired heating profile and processing time.

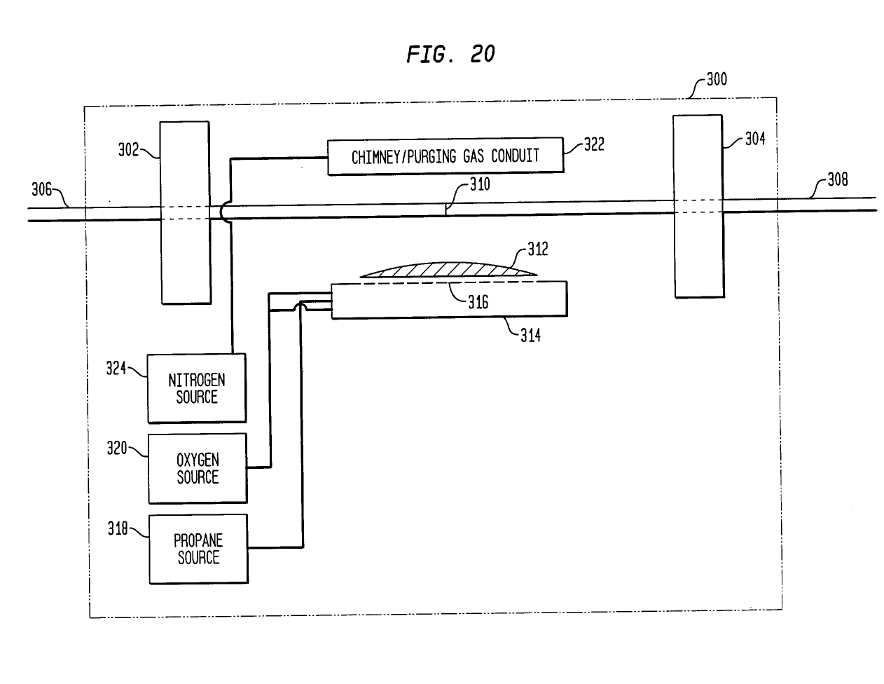

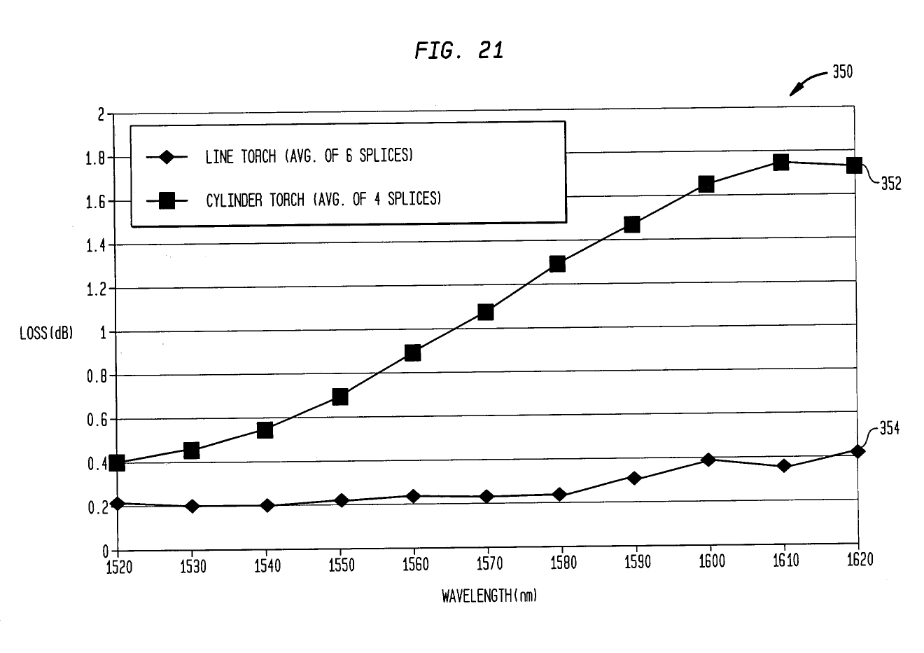

FIG. 20 shows a diagram of a TEC treatment station 300 according to a further aspect of the invention. The station 300 includes a pair of fiber holding clamps 302 and 304 for holding a pair of spliced fibers 306 and 308 that have been spliced together at a splice point 310. The fibers 306 and 308 are positioned in the station 300 such that the splice point 310 is positioned over an elongated flame 312 generated by a line torch 314 having formed therein an array of orifices 316 for releasing a stream of propane, or other flammable gas from a propane source 318. In the TEC station 300 shown in FIG. 20, oxygen is fed to the flame 312 from an oxygen source 320. In addition, a chimney and purging gas conduit, fabricated as a combined unit 322, are positioned above the flame 312 and fibers 306, 308. The purging gas conduit 322 delivers a purging gas to the surface of the fibers 306, 308.

The above-described configurations of line torches have been tested on a number of different splice combinations, involving different types of optical fiber. The smaller modefield diameter fibers used included the following fibers manufactured by OFS Fitel: Dispersion Compensating Fiber (DCF); Inversion Dispersion Fiber (IDF); Highly Non-Linear Fiber (HNLF); and Extra High Slope DCF (EHS). The larger modefield diameter fibers used included the following fibers manufactured by OFS Fitel: Standard Single Mode Fiber (SSMF) and Super Large Area Fiber (SLA). Specifically, the following splice combinations were tested: (1) SSMF-DCF, (2) SLA-IDF, and (3) SSMF-HNLF.

The modefield diameter of SSMF is approximately 10 microns, and the modefield diameter of SLA is approximately 12 microns. DCF, IDF, and HNLF have modefield diameters that range from 3 microns to 7 microns. Because of the mismatch in modefield diameters, significant splice loss results when SSMF or SLA is spliced to DCF, IDF or HNLF, unless the modefield diameter mismatch issue is addressed. As discussed above, although currently used TEC techniques produce some reduction in splice loss, it is possible to achieve superior results using a line torch system, such as those described herein.

FIGS. 21-27 show a series of graphs and tables setting forth results obtained using the above described torches to treat different splice combinations. Where not otherwise specified, the loss data set forth in FIGS. 21-27 refer to losses measured at a wavelength of 1550 nm.

In each set of trials, a first fiber was fusion spliced to a second fiber and then loaded into a thermal treatment station for TEC processing. Splice loss was monitored during the TEC process. Generally speaking, splice loss typically decreases relatively rapidly at the beginning of TEC processing. The amount of splice loss reduction then flattens out until it reaches a maximum level of reduction. Thus, the TEC processing of the samples was halted when this maximum level of splice loss reduction was achieved.

FIG. 21 shows a graph 350 comparing splice loss, as a function of wavelength, resulting from TEC performed using a cylindrical torch (upper trace 352), and splice loss resulting from TEC performed using the line torch 170 shown in FIG. 10 (lower trace 354), in an EHS-SSMF splice combination. As shown in FIG. 20, the use of a line torch results in a significant reduction in splice loss compared with the splice loss resulting from the use of a cylinder torch.

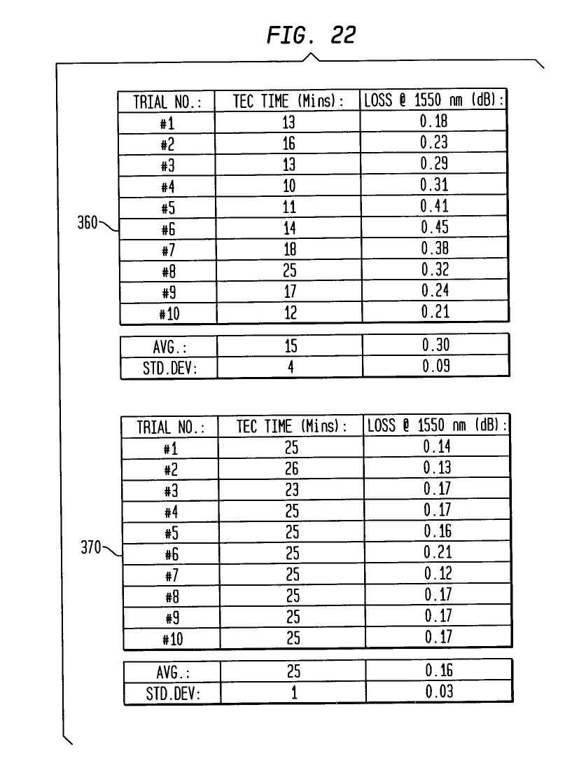

FIG. 22 shows a pair of tables 360 and 370 setting forth TEC processing time and measured splice loss for ten sample splice combinations, in which IDF was spliced to SLA. The upper table 360 sets forth processing times and splice losses for a cylindrical torch TEC process, and the lower table 370 sets forth processing times and splice losses for a line torch TEC process using the line torch 190 shown in FIG. 12.

The data in the tables 360 and 370 shown in FIG. 22 illustrate the improvement in splice loss and loss repeatability using the new torch. It will be seen from these data that the average splice loss achieved at 1550 nm was 0.30 dB for the cylindrical torch TEC and 0.16 dB for the line torch TEC. In this example, the average processing time was 15 minutes for the cylindrical torch and 25 minutes for the line torch. However, as discussed below, processing time for the line torch may be significantly reduced by adding an oxygen feed to the line torch.

Further illustrated in the tables 360 and 370 shown in FIG. 22 is the repeatability of results using the line torch. As shown in the lower table 370 in FIG. 22, using the line torch achieved an average splice loss of 0.16 dB with a standard deviation of 0.03. Using the cylindrical torch achieved an average splice loss of 0.30 dB with a standard deviation of 0.09 dB. Thus, the line torch produced significantly more consistent results. In addition, the standard deviation for line torch processing time was 1 minute, whereas the standard deviation for cylindrical torch processing time was 4 minutes, a further indication of repeatability.

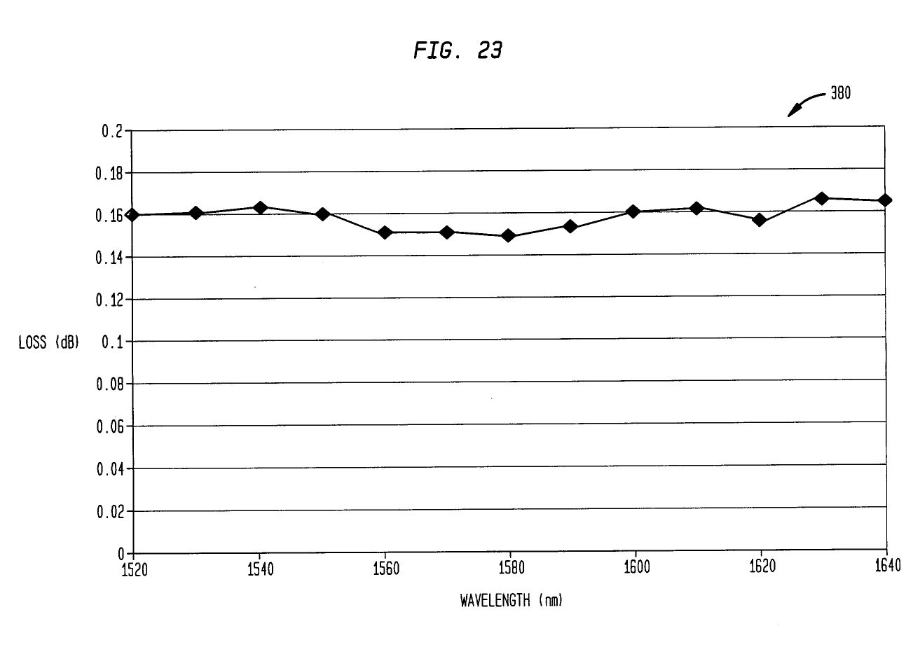

FIG. 23 shows a graph 380 illustrating splice loss as a function of wavelength for the line torch TEC-treated fibers, the results for which are set forth in the lower table 370 in FIG. 22. The data points in the graph were computed by averaging measured splice loss for each of the ten samples at wavelengths ranging from 1520 to 1640 nm. As shown in FIG. 23, the resulting graph is substantially flat, indicating that the amount of splice loss in line torch TEC-treated fibers is substantially wavelength-independent in the tested range of wavelengths.

One important TEC issue is its relatively long processing time. To date, no one has reported processing times below 10 minutes for TEC treatment of splice combinations including OFS Fitel DCF or IDF. However, it has been found that using the line torch configuration shown in FIG. 14, in which oxygen is fed from a pair of orifice arrays straddling the propane orifice array, it is possible to achieve processing times below 10 minutes. It is believed that this decrease in processing time is caused by the lower gradient heat profile combined with the increased flame temperature caused by the addition of oxygen.

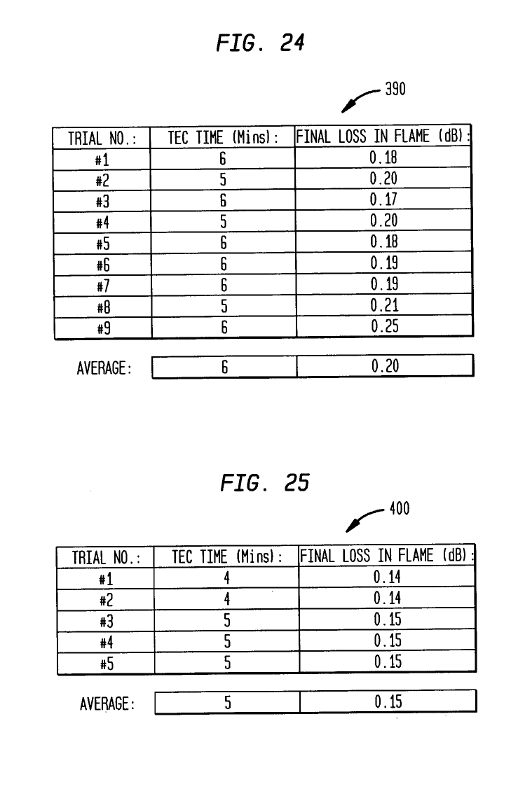

FIG. 24 shows a table 390 setting forth processing times and final splice losses for nine sample IDF-SLA splice combinations using the line torch configuration shown in FIG. 14. In each of the trials, a length of IDF was fusion spliced to a length of SLA. The spliced fibers were then removed from the fusion splicer and loaded into a TEC treatment station having the line torch configuration shown in FIG. 14. Splice loss was monitored while the TEC process was being performed. When a minimum splice loss value was achieved, the amount of TEC treatment time, and the amount of splice loss were recorded. As shown in FIG. 24, the average amount of TEC treatment time was only 6 minutes, a significant reduction in processing time. In the table shown in FIG. 22, the average TEC time using a line torch without added oxygen was 25 minutes.

FIG. 25 shows a table 400 setting forth the processing time and final splice loss data for an SSMF-DCF splice combination using the same line torch configuration that was used for the table shown in FIG. 24. In prior trials using a cylindrical line torch, average TEC processing times ranged from 10 to 20 minutes. As shown in FIG. 25, using a line torch with added oxygen, the average TEC processing time was only 5 minutes.

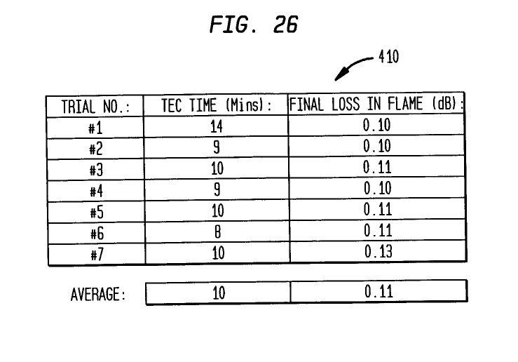

FIG. 26 shows a table 410 setting forth TEC processing times and splice loss data for an HNLF-SSMF splice combination, again using the line torch with added oxygen. As shown in FIG. 26, the average TEC processing time was 10 minutes. Using a cylinder torch, TEC processing times of up to 40 minutes are typically required.

Another issue raised by TEC processing is strength degradation that may occur during heat treatment. One approach for maintaining strength after TEC processing is to use a line torch configuration, such as that illustrated in FIG. 19 and discussed above. The issue of splice strength is important, for example, in an SLA-IDF splice combination. One use for this combination of fibers is in submarine systems, where 200 kpsi strength is required.

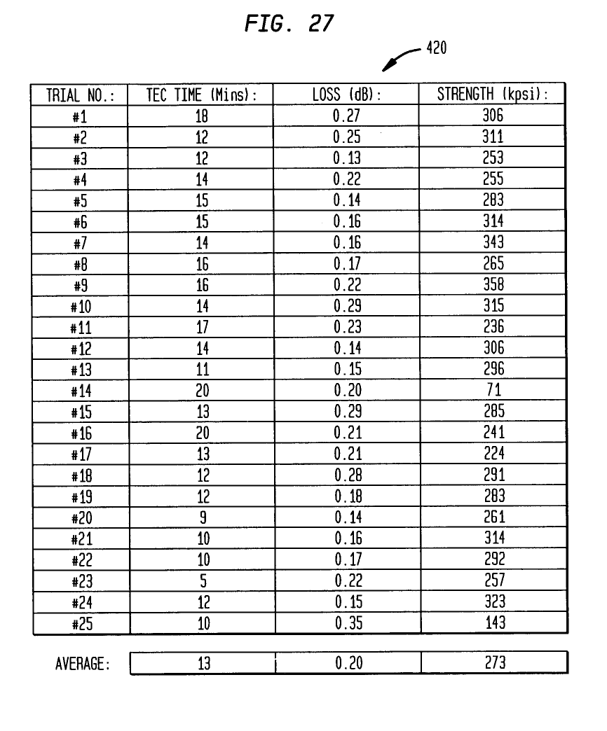

FIG. 27 shows a table 420 setting forth processing time, splice loss, and strength data for 25 sample IDF-SLA splices. The splices were proof-tested at 235 kpsi prior to TEC processing. A value of 235 kpsi, rather than 200 kpsi, is used for testing purposes to increase the certainty that all tested fibers will satisfy the 200 kpsi requirement after the fibers have left the factory.

Because of the pre-TEC proof testing, it was known that 100% of the fiber samples satisfied the 235 kpsi requirement prior to the TEC treatment. As shown in FIG. 27, 22 out of the 25 splices, or 88%, met the 235 kpsi requirement after TEC, with an average splice loss of 0.20 dB at 1550 nm. The average TEC processing time for the sample splices was 13 minutes.

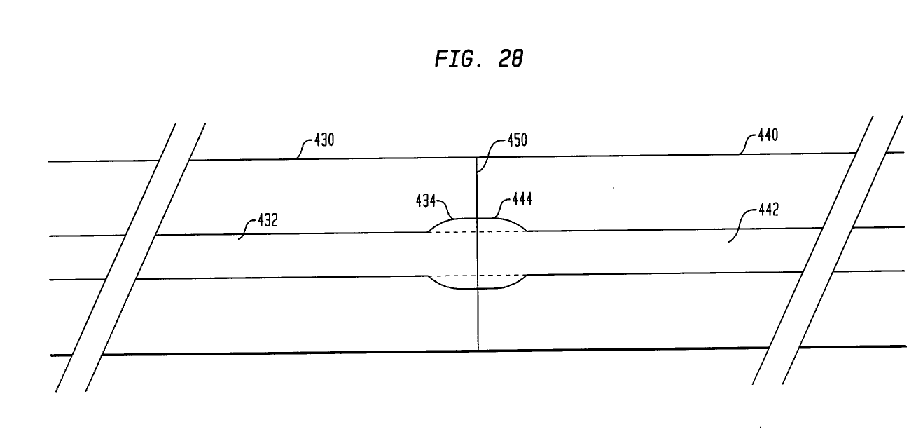

FIGS. 28-30 are a series of diagrams illustrating a further aspect of the invention, in which a line torch, such as any of the torches shown in FIGS. 10, 12, 14, or 16, is used to treat splices between fibers having the same modefield diameter, or even to treat splices between fibers of the same type. A TEC treatment of such splices is particularly useful where one or both of the spliced fibers are of a type that is particularly sensitive to heat. In a typical fusion splicing operation, the spliced fibers are exposed to heat for a relatively short amount of time. However, where a fiber is particularly heat-sensitive, even that short exposure to heat may cause a perturbation in the splice region, leading to mode coupling and splice loss.

FIG. 28 shows a diagram, not drawn to scale, of a first fiber 430 that has been fusion spliced to a second fiber 440 at a splice point 450. The two fibers 430 and 440 have modefields 432 and 442 with the same diameter. Each of the fiber modefields 432 and 442 undergoes a certain amount of expansion 434 and 444 in the splice region. However, because the fiber modefields have the same diameter, there is no modefield diameter mismatch at the splice point 450. There may nonetheless be a certain amount of splice loss caused by perturbations or discontinuities in the portions 434 and 444 of the fiber modefields that have expanded as a result of the splicing process.

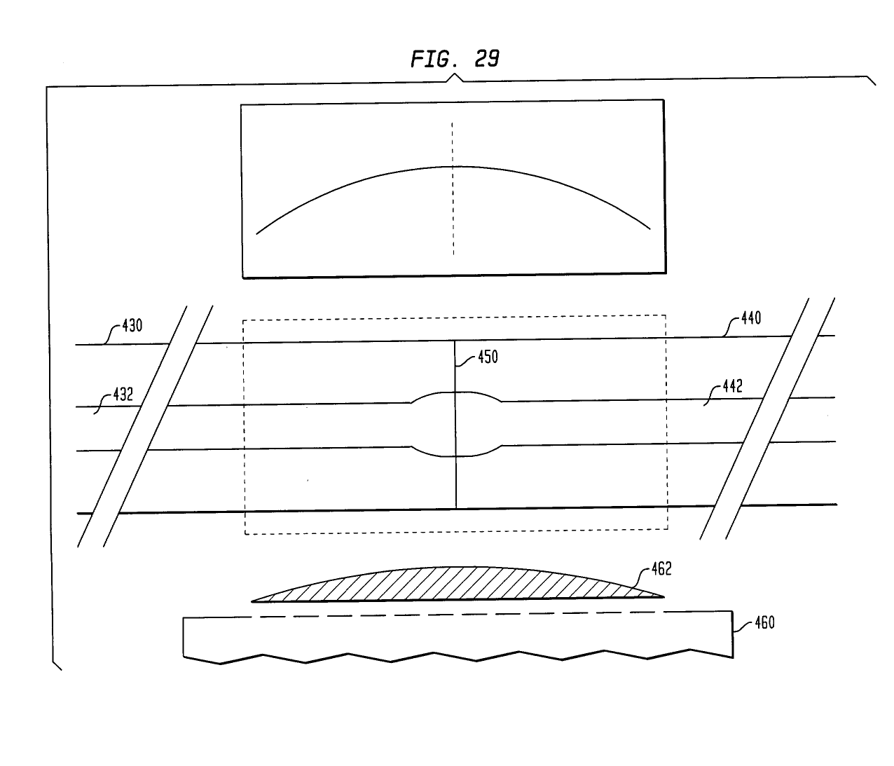

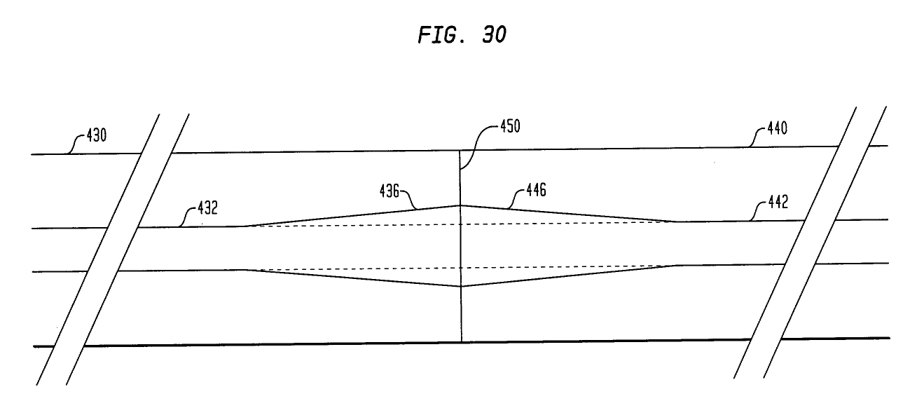

A line torch may be used to smooth out the expanded modefield portions. In FIG. 29, the spliced fibers have been loaded into a TEC treatment station having a line torch 460. The splice point 450 is centered over the peak of the elongated flame 462 created by the line torch 460. FIG. 30 shows a diagram of the treated fibers 430 and 440. As shown in FIG. 30, the transition regions 436 and 446 in the two fibers have been smoothed out, thereby reducing splice loss.

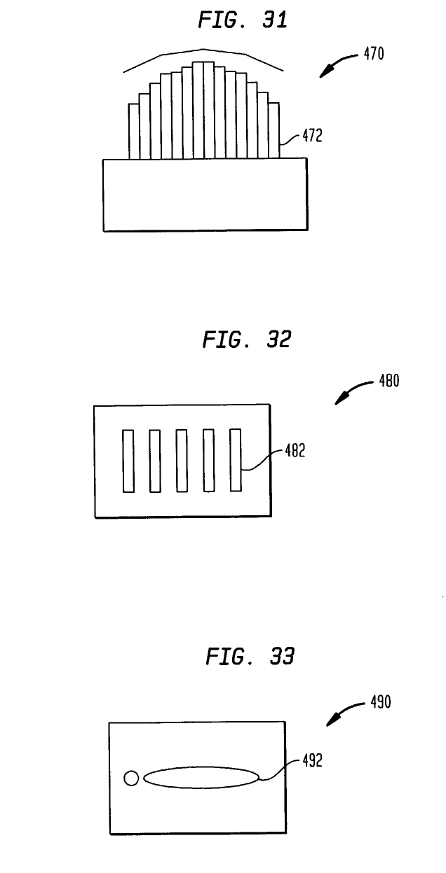

FIGS. 31-33 are a series of diagrams illustrating other ways of implementing the line torch principle. In FIG. 31, the line torch 470 has been implemented using a plurality of microcylinders 472 that have been mounted together to form a torch. The cylinders release a flammable gas, such as propane, that is fed to the microcylinders from an inlet. The heating profile of the resulting flame can be tailored by adjusting the diameter and height of the microcylinders 472. Also, the cylinders 472 may be spaced apart, as needed, to achieve a desired profile.

FIG. 32 shows another line torch 480, in which the orifices have been implemented in the form of slots 482 that have been cut into a hollow body. The use of slots 482 allows the creation of a wider flame, which may be useful in certain situations.

FIG. 33 shows another line torch 490, in which several orifices have been combined into a single, elongated orifice 492. In this example, the elongated orifice 492 is elliptical in shape. However, other shapes may be used to achieve a desired heating profile.

It should also be noted that a line torch according to the present invention can also be used as the heat source in a pre-splice heat treatment. In one pre-splice heat treatment, for example, a fiber requiring modefield expansion is loaded into a pre-splice heat treatment station. The lead end of the fiber is then heated to expand the fiber's modefield in preparation for splicing. Once the pre-splice heat treatment has been completed, the fiber end is then spliced to a second fiber.

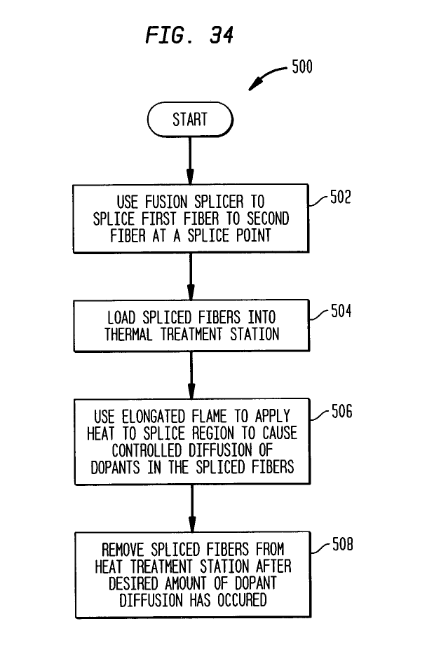

FIG. 34 shows a flowchart of a method 500 according to a further aspect of the invention. In step 502, a fusion splicer is used to splice together a first fiber and a second fiber at a splice point. In step 504, the spliced fibers are loaded into a thermal treatment station. In step 506, an elongated flame is used to apply heat to the splice region to cause a controlled diffusion of dopants in the spliced fibers. As discussed above, this controlled diffusion causes an expansion of the fibers' modefield diameters, thereby reducing splice loss arising from modefield diameter mismatch. In step 508, the spliced fibers are removed from the heat treatment stations after a desired amount of dopant diffusion has occurred.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

We claim:

1. A torch for performing a thermally-diffused expanded core technique, comprising:
a hollow body;
a conduit for delivering a flammable gas to the hollow body, the flammable gas streaming out of an array of orifices formed in the hollow body,
the orifices being shaped and arranged in the array such that when the streaming gas is ignited, a substantially continuous elongated flame is created having a desired heating profile.

2. The torch of claim 1, wherein the array of orifices is linear.

3. The torch of claim 2, wherein the heating profile is tailored by adjusting the size of the orifices in the array.

4. The torch of claim 2, wherein the orifices are the same size, and wherein the heating profile is tailored by adjusting the position of the orifices in the array.

5. The torch of claim 4, wherein the orifices are symmetrical around a central point in the array.

6. The torch of claim 5, wherein the orifices are positioned in the array such that the elongated flame has a central peak.

7. The torch of claim 2, further including:
a pair of conduits straddling the hollow body, each conduit having an array of orifices for releasing a stream of oxygen to increase the temperature of the elongated flame.

8. The torch of claim 7, wherein the arrays of orifices in the conduits are linear, and wherein the arrays of orifices in the conduits and the array of orifices in the hollow body are substantially parallel to each other.

9. The torch of claim 8, wherein the hollow body and conduits are fabricated by forming holes and orifices in a block of material.

10. The torch of claim 1, further including:
a conduit for delivering a purging gas to a pair of spliced fibers being heat treated by the elongated flame.

11. The torch of claim 10, further including:
a chimney positioned over the elongated flame, the purging gas conduit surrounding the chimney.

12. A station for thermally treating a pair of optical fibers spliced together at a splice point, comprising:
a torch including a hollow body and a conduit for receiving a flammable gas, the flammable gas streaming out of an array of orifices formed in the hollow body, the orifices being shaped and arranged in the array such that when the streaming gas is ignited, a substantially continuous elongated flame is created having a desired heating profile;
a pair of fiber clamps for holding the pair of spliced optical fibers with the splice point positioned over the elongated flame.

13. The station of claim 12, wherein the heating profile has a central peak, and wherein the splice point is positioned over the central peak.

14. The station of claim 12, wherein the array of orifices is substantially linear, and wherein the spliced fibers are positioned such that their longitudinal axes are substantially parallel with the array of orifices.

15. The station of claim 12, wherein the torch further includes a pair of conduits straddling the hollow body, each conduit having formed therein an array of orifices for delivering oxygen to the elongated flame.

16. The station of claim 15, wherein the array of orifices on the hollow body and the arrays of orifices on the conduits are substantially linear, and wherein the arrays are substantially parallel with each other.

17. The station of claim 15, further including a conduit for delivery a purging gas to the spliced fibers.

18. The station of claim 17, further including a chimney positioned over the elongated flame, and wherein the purging gas conduit surrounds the chimney.

19. A method for reducing splice loss in an optical fiber transmission line, comprising:
fusion splicing a first fiber to a second fiber at a splice point;
loading the spliced fibers into a thermal treatment station;
positioning the splice point over an elongated flame; and
applying heat to the splice point to cause a diffusion of dopants.

20. The method of claim 19, further including:
adding oxygen to the elongated flame to increase its temperature.

21. The method of claim 20, further including:
delivering a purging gas to the spliced fibers while it is heated.
